(19) United States
(12) Patent Application Publication
(10) Pub. No.: US 2026/0253801 A1
(43) Pub. Date: Aug. 27, 2026

(54) ELECTRICAL DEVICE

(71) Applicant: DENSO CORPORATION, Kariya-city (JP)

(72) Inventor: Sho HASHIMOTO, Kariya-city (JP)

(73) Assignee: DENSO CORPORATION, Kariya-city (JP)

(21) Appl. No.: 19/648,149

(22) Filed: Apr. 15, 2026

Related U.S. Application Data
(63) Continuation of application No. PCT/JP2024/037357, filed on Oct. 21, 2024.

(30) Foreign Application Priority Data
Oct. 26, 2023 (JP) 2023-184261

(51) Int. Cl. H01G 4/224; H01G 2/08; H01G 4/38

(52) U.S. Cl. CPC H01G 4/224; H01G 2/08; H01G 4/38

(57) ABSTRACT

An electrical device includes a power supply busbar, a capacitor, a metal housing, and a heat dissipation member. The power supply busbar is connected to a power source and an electric component. The capacitor is connected to the power supply busbar and connected to a ground. The metal housing includes a bottom connected to the ground, to which the capacitor is fixed. The heat dissipation member has an electrically insulating property and a thermal conductivity higher than a thermal conductivity of air. The capacitor includes an element and a capacitor busbar. The capacitor busbar includes a first busbar connecting the element and the power supply busbar, a second busbar connecting the element and the ground, and a fixed busbar extending from the first busbar or the second busbar toward the bottom and fixed to the bottom. The heat dissipation member is disposed between the fixed busbar and the bottom.

### CROSS REFERENCE TO RELATED APPLICATIONS

The present application is a continuation application of International Patent Application No. PCT/JP2024/037357 filed on October 21, 2024, which designated the U.S. and claims the benefit of priority from Japanese Patent Application No. 2023-184261 filed on October 26, 2023. The entire disclosures of all the above applications are incorporated herein by reference.

### TECHNICAL FIELD

The disclosure described in this description relates to electrical device.

### BACKGROUND

A resin-molded capacitor has a case, a capacitor element accommodated in the case, a busbar attached to the capacitor element, a resin member enclosing the capacitor element and the busbar, and a heat dissipation member extending from an inside of the resin member to an outside of the resin member.

### SUMMARY

According to at least one embodiment of the present disclosure, an electrical device includes a power supply busbar, a capacitor, a metal housing, and a heat dissipation member. The power supply busbar is connected to a power source and an electric component. The capacitor is connected to the power supply busbar and connected to a ground. The metal housing includes a bottom to which the capacitor is fixed. The bottom is connected to the ground. The heat dissipation member has an electrically insulating property and a thermal conductivity higher than a thermal conductivity of air. The capacitor includes an element and a capacitor busbar. The capacitor busbar includes a first busbar connecting the element and the power supply busbar, a second busbar connecting the element and the ground, and a fixed busbar extending from the first busbar or the second busbar toward the bottom and fixed to the bottom. The heat dissipation member is disposed between the fixed busbar and the bottom.

### BRIEF DESCRIPTION OF DRAWINGS

The details of one or more embodiments are set forth in the accompanying drawings and the description below. Other features and advantages will be apparent from the description and drawings, and from the claims.

FIG. 1 is an electric circuit diagram of an electrical device.

FIG. 2 is a side view of the electrical device.

FIG. 3 is a planar view of the electrical device viewed from a back surface.

FIG. 4 is a cross-sectional view taken along line IV-IV in FIG. 3.

FIG. 5 is a cross-sectional view taken along line V-V in FIG. 3.

FIG. 6 is a cross-sectional view taken along line VI-VI in FIG. 3.

FIG. 7 is a cross-sectional view taken along line VII-VII in FIG. 3.

FIG. 8 is a planar view of an electrical device according to a second embodiment viewed from a back surface.

### DETAILED DESCRIPTIONS

A resin-molded capacitor has a case, a capacitor element accommodated in the case, a busbar attached to the capacitor element, a resin member enclosing the capacitor element and the busbar, and a heat dissipation member extending from an inside of the resin member to an outside of the resin member.

According to the configuration of a comparative example, heat transferred to the capacitor element and the busbar can be transferred to the outside via the resin member and the heat dissipation member. However, due to presence of the resin member, heat could not be efficiently released to the heat dissipation member. The temperature of the capacitor element may rise due to heat accumulation in the resin member.

In contrast to the comparative example, according to the present disclosure, an electrical device is capable of reducing temperature rise of an element.

According to at least one embodiment of the present disclosure, an electrical device includes a power supply busbar, a capacitor, a metal housing, and a heat dissipation member. The power supply busbar is connected to a power source and an electric component. The capacitor is connected to the power supply busbar and connected to a ground. The metal housing includes a bottom to which the capacitor is fixed. The bottom is connected to the ground. The heat dissipation member has an electrically insulating property and a thermal conductivity higher than a thermal conductivity of air. The capacitor includes an element and a capacitor busbar. The capacitor busbar includes a first busbar connecting the element and the power supply busbar, a second busbar connecting the element and the ground, and a fixed busbar extending from the first busbar or the second busbar toward the bottom and fixed to the bottom. The heat dissipation member is disposed between the fixed busbar and the bottom.

According to this, heat generated by energization of the power supply busbar is transferred to the bottom via the fixed busbar and the heat dissipation member. Accordingly, heat transferred to the element is reduced. A temperature rise of the element can be reduced.

Hereinafter, multiple embodiments for carrying out the present disclosure will be described with reference to the drawings. In each embodiment, parts corresponding to matters described in a preceding embodiment may be denoted by the same reference numerals, and redundant description may be omitted. When only a part of a configuration is described in each embodiment, other embodiments described previously can be applied to other parts of the configuration.

Further, not only combinations of parts explicitly stated to be combinable in each embodiment, but also partial combinations of embodiments, or of an embodiment and a modification, or of modifications with each other are possible even if not explicitly stated, as long as no particular hindrance to the combination arises.

### First Embodiment

### In-Vehicle System

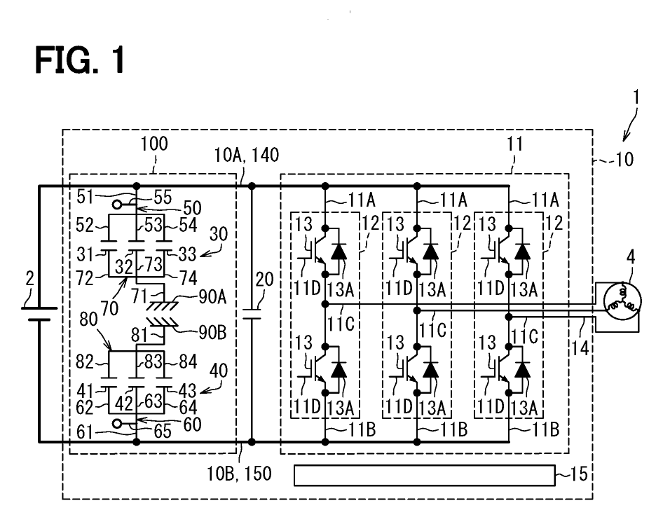

FIG. 1 is an electric circuit diagram of an electrical device 10 mounted on an in-vehicle system 1. The electrical device 10 may also be referred to as a power conversion device. A high-voltage battery 2, a motor generator 4, and the electrical device 10 are mounted on the in-vehicle system 1. A vehicle on which the in-vehicle system 1 is mounted is a hybrid vehicle capable of traveling by switching between or combining a driving force of an engine and a driving force of the motor generator 4. The engine and the motor generator 4 are connected to each other via a gear device 5. The gear device 5 has a role of transmitting power.

The electrical device 10 includes a positive-electrode-side high-voltage wiring 10A, a negative-electrode-side high-voltage wiring 10B, an inverter 11, a connecting busbar 14, a control circuit board 15, a smoothing capacitor 20, a Y-capacitor 100, and a housing 120. The positive-electrode-side high-voltage wiring 10A is a wiring connected to a positive electrode of the high-voltage battery 2. The negative-electrode-side high-voltage wiring 10B is a wiring connected to a negative electrode of the high-voltage battery 2. The positive-electrode-side high-voltage wiring 10A is constituted by an electrically conductive member such as a positive-electrode-side power supply busbar 140. The negative-electrode-side high-voltage wiring 10B is constituted by an electrically conductive member such as a negative-electrode-side power supply busbar 150. The positive-electrode-side power supply busbar 140 and the negative-electrode-side power supply busbar 150 may be collectively referred to as power supply busbars 140, 150.

The inverter 11 is connected to the positive-electrode-side high-voltage wiring 10A and the negative-electrode-side high-voltage wiring 10B. The inverter 11 includes multiple semiconductor modules 12. Each semiconductor module 12 includes two switching elements 13 and two diodes 13A. The two switching elements 13 are connected in series between the positive-electrode-side high-voltage wiring 10A and the negative-electrode-side high-voltage wiring 10B.

A positive-electrode-side input terminal 11A is connected to a collector electrode of one of the two switching elements 13, which is provided on a high potential side. A negative-electrode-side input terminal 11B is connected to an emitter of another of the two switching elements 13, which is provided on a low potential side. An anode of each diode 13A is connected to an emitter of the corresponding switching element 13. A cathode of each diode 13A is connected to a collector of the corresponding switching element 13.

Each motor terminal 11C leading to the motor generator 4 is connected to the emitter of the one of the two switching elements 13 on the high potential side and the collector of the other of the two switching elements 13 on the low potential side. The multiple switching elements 13 convert DC power supplied from the high-voltage battery 2 into AC power with which the motor generator 4 can be driven. The power-converted electric power is supplied to the motor generator 4 via the connecting busbar 14.

The control circuit board 15 controls on/off of the multiple switching elements 13. A control circuit that controls on/off of the multiple switching elements 13 is mounted on the control circuit board 15. Connection terminals 11D of the multiple switching elements 13 are solder-connected to the control circuit board 15. The connection terminals 11D of the multiple switching elements 13 are electrically connected to the control circuit board 15.

The smoothing capacitor 20 mainly smooths a DC voltage supplied from the high-voltage battery 2. The smoothing capacitor 20 is connected to the positive-electrode-side high-voltage wiring 10A and the negative-electrode-side high-voltage wiring 10B. The smoothing capacitor 20 is connected in parallel to the inverter 11 and the Y-capacitor 100. The high-voltage wirings 10A, 10B electrically connect the inverter 11, the smoothing capacitor 20, the Y-capacitor 100, and the high-voltage battery 2.

The Y-capacitor 100 mainly removes noise components leaking from the inverter 11. The Y-capacitor 100 of the present embodiment includes six elements 31, 32, 33, 41, 42, and 43, two Y-capacitor busbars 30 and 40, two cases 160 and 170, two fastening members 91 and 92, and two heat dissipation members 131 and 132. The number of elements is not limited to six. The number of elements may be at least two or more. The Y-capacitor 100 includes a positive-electrode-side Y-capacitor 100A and a negative-electrode-side Y-capacitor 100B. The positive-electrode-side Y-capacitor 100A and the negative-electrode-side Y-capacitor 100B will be described later.

Three of the six elements 31, 32, 33, 41, 42, and 43 may be referred to as positive-electrode-side elements 31, 32, and 33. The positive-electrode-side elements 31, 32, and 33 include a positive-electrode-side first element 31, a positive-electrode-side second element 32, and a positive-electrode-side third element 33. The remaining three may be referred to as negative-electrode-side elements 41, 42, 43. The negative-electrode-side elements 41, 42, 43 include a negative-electrode-side first element 41, a negative-electrode-side second element 42, and a negative-electrode-side third element 43.

One of the two Y-capacitor busbars 30, and 40 may be referred to as a positive-electrode-side Y-capacitor busbar 30. The remaining one may be referred to as a negative-electrode-side Y-capacitor busbar 40. One of the two cases 160, and 170 may be referred to as a positive-electrode-side case 160. The remaining one may be referred to as a negative-electrode-side case 170. The positive-electrode-side Y-capacitor busbar 30 may be referred to as a positive-electrode-side capacitor busbar. The negative-electrode-side Y-capacitor busbar 40 may be referred to as a negative-electrode-side capacitor busbar.

The three positive-electrode-side elements 31, 32, and 33, the positive-electrode-side Y-capacitor busbar 30, the positive-electrode-side case 160, the fastening member 91, and the heat dissipation member 131 may be collectively referred to as the positive-electrode-side Y-capacitor 100A. The three negative-electrode-side elements 41, 42, and 43, the negative-electrode-side Y-capacitor busbar 40, the negative-electrode-side case 170, the fastening member 92, and the heat dissipation member 132 may be collectively referred to as the negative-electrode-side Y-capacitor 100B.

The positive-electrode-side elements 31, 32, and 33 are accommodated in the positive-electrode-side case 160. The positive-electrode-side Y-capacitor busbar 30 connects the positive electrode of the high-voltage battery 2 and a first ground 90A via the positive-electrode-side elements 31, 32, and 33. The positive-electrode-side elements 31, 32, and 33 have positive-electrode-side leads 31A, 32A, and 33A connected to the positive electrode of the high-voltage battery 2, and positive-electrode-side G-leads 31B, 32B, and 33B connected to the first ground 90A. The positive-electrode-side leads 31A, 32A, and 33A include a positive-electrode-side first lead 31A, a positive-electrode-side second lead 32A, and a positive-electrode-side third lead 33A. The positive-electrode-side G-leads 31B, 32B, and 33B include a positive-electrode-side first G-lead 31B, a positive-electrode-side second G-lead 32B, and a positive-electrode-side third G-lead 33B.

The positive-electrode-side Y-capacitor busbar 30 includes a positive-electrode-side first busbar 50, a positive-electrode-side second busbar 70, and a positive-electrode-side fixed busbar 55. The positive-electrode-side first busbar 50 electrically connects the positive electrode of the high-voltage battery 2 and the positive-electrode-side leads 31A, 32A, and 33A. The positive-electrode-side second busbar 70 electrically connects the positive-electrode-side G-leads 31B, 32B, and 33B and the first ground 90A. One end of the positive-electrode-side fixed busbar 55 is integrally connected to the positive-electrode-side first busbar 50. The other end of the positive-electrode-side fixed busbar 55 is fixed to a back surface 110B of a bottom 110 of the housing 120, which is described later, via the heat dissipation member 131. The positive-electrode-side first busbar 50 and the positive-electrode-side leads 31A, 32A, and 33A are connected via solder 34. The positive-electrode-side second busbar 70 and the positive-electrode-side G-leads 31B, 32B, and 33B are connected via solder 35.

Further, the positive-electrode-side second busbar 70 includes a fastened portion 75 provided with the fastening member 91. The fastened portion 75 is fixed to the bottom 110 via the fastening member 91, thereby being electrically connected to the first ground 90A. The positive-electrode-side elements 31, 32, and 33 direct noise components leaking from the inverter 11 to the first ground 90A via the positive-electrode-side second busbar 70 and the fastening member 91.

Similarly, the negative-electrode-side elements 41, 42, and 43 are accommodated in the negative-electrode-side case 170. The negative-electrode-side Y-capacitor busbar 40 connects the negative electrode of the high-voltage battery 2 and a second ground 90B via the negative-electrode-side elements 41, 42, and 43. The negative-electrode-side elements 41, 42, and 43 include negative-electrode-side leads 41A, 42A, and 43A connected to the negative electrode of the high-voltage battery 2, and negative-electrode-side G-leads 41B, 42B, and 43B connected to the second ground 90B. The negative-electrode-side leads 41A, 42A, and 43A include a negative-electrode-side first lead 41A, a negative-electrode-side second lead 42A, and a negative-electrode-side third lead 43A. The negative-electrode-side G-leads 41B, 42B, and 43B include a negative-electrode-side first G-lead 41B, a negative-electrode-side second G-lead 42B, and a negative-electrode-side third G-lead 43B.

The negative-electrode-side Y-capacitor busbar 40 includes a negative-electrode-side first busbar 60, a negative-electrode-side second busbar 80, and a negative-electrode-side fixed busbar 65. The negative-electrode-side first busbar 60 electrically connects the negative electrode of the high-voltage battery 2 and the negative-electrode-side leads 41A, 42A, and 43A. The negative-electrode-side second busbar 80 electrically connects the negative-electrode-side G-leads 41B, 42B, and 43B and the second ground 90B. One end of the negative-electrode-side fixed busbar 65 is integrally connected to the negative-electrode-side first busbar 60. The other end of the negative-electrode-side fixed busbar 65 is fixed to the back surface 110B of the bottom 110 via the heat dissipation member 132. The negative-electrode-side first busbar 60 and the negative-electrode-side leads 41A, 42A, and 43A are connected via solder 44. The negative-electrode-side second busbar 80 and the negative-electrode-side G-leads 41B, 42B, and 43B are connected via solder 45.

The positive-electrode-side first lead 31A, the positive-electrode-side second lead 32A, the positive-electrode-side third lead 33A, the negative-electrode-side first lead 41A, the negative-electrode-side second lead 42A, and the negative-electrode-side third lead 43A may be collectively referred to as one end leads. The positive-electrode-side first G-lead 31B, the positive-electrode-side second G-lead 32B, the positive-electrode-side third G-lead 33B, the negative-electrode-side first G-lead 41B, the negative-electrode-side second G-lead 42B, and the negative-electrode-side third G-lead 43B may be collectively referred to as other end leads.

Further, the negative-electrode-side second busbar 80 includes a fastened portion 85 provided with the fastening member 92. The fastened portion 85 is fixed to the bottom 110 via the fastening member 92, thereby being electrically connected to the second ground 90B. The negative-electrode-side elements 41, 42, and 43 direct noise components leaking from the inverter 11 to the second ground 90B via the negative-electrode-side second busbar 80 and the fastening member 92.

The heat dissipation members 131 and 132 are heat dissipation sheets, gap fillers, or heat dissipation grease, for example. The heat dissipation members 131 and 132 have a higher thermal conductivity than that of air. The heat dissipation members 131, 132 have an insulating property. As will be described in detail later, the heat dissipation members 131 and 132 are provided between the Y-capacitor busbars 30, 40 and the bottom 110. The heat dissipation members 131 and 132 efficiently transfer heat from the Y-capacitor busbars 30 and 40 to the bottom 110.

### Mechanical Configuration of the Electrical Device

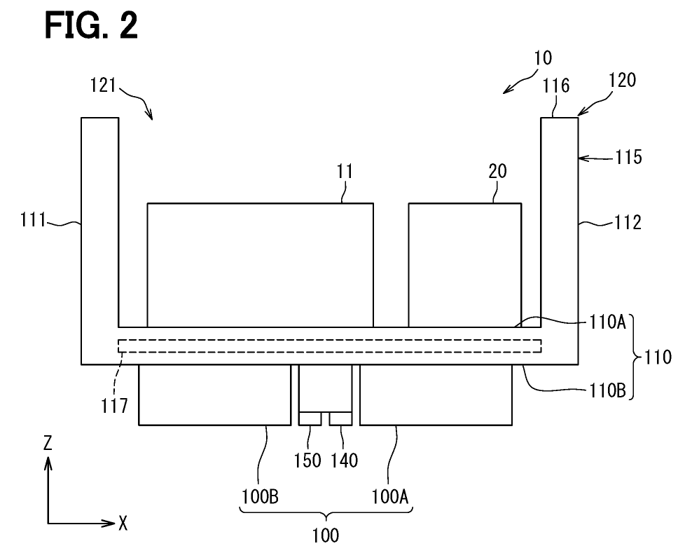

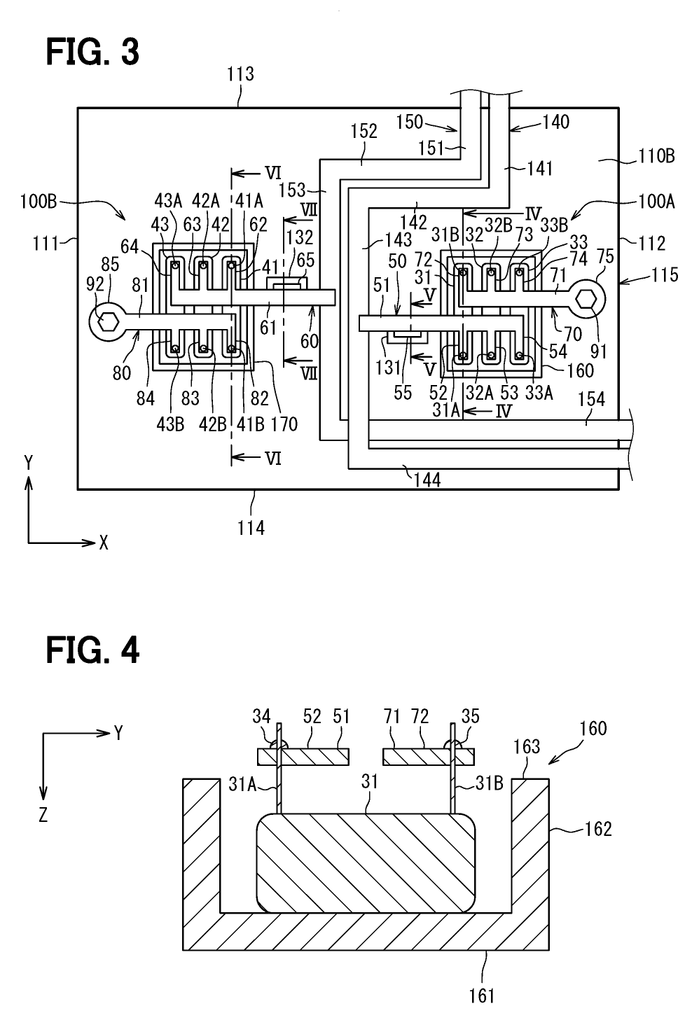

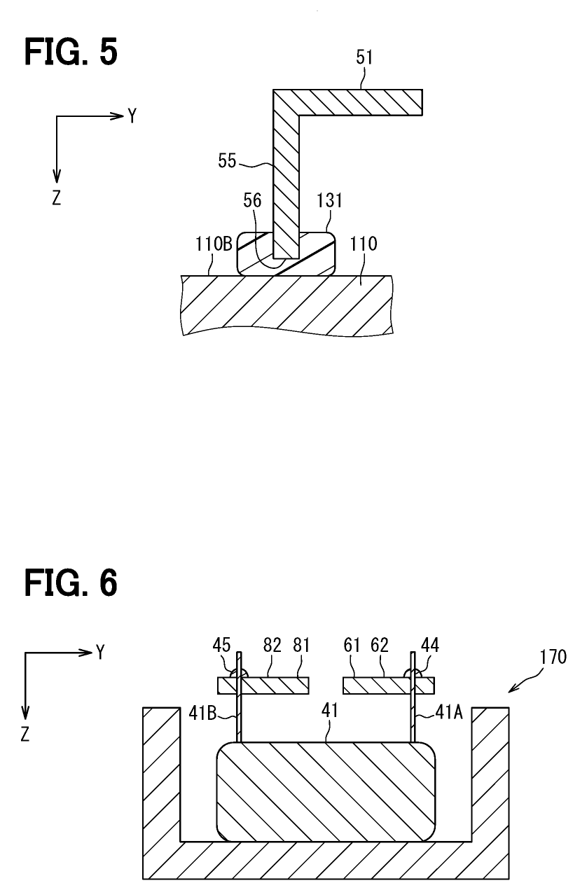

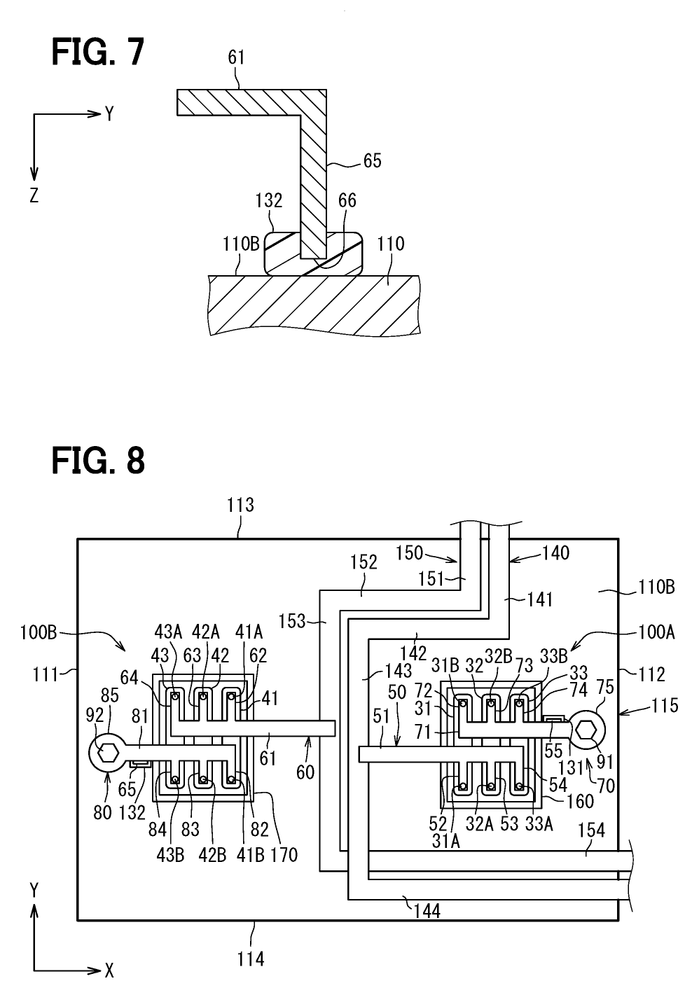

Before describing a mechanical configuration of the electrical device 10, the drawings will be described first. FIG. 1 is an electric circuit diagram of the electrical device 10. FIG. 2 is a side view of the electrical device 10. FIG. 3 is a planar view of the electrical device 10 viewed from the back surface 110B. FIG. 4 is a cross-sectional view of the positive-electrode-side Y-capacitor 100A. FIG. 5 is a cross-sectional view of the positive-electrode-side fixed busbar 55. FIG. 6 is a cross-sectional view of the negative-electrode-side Y-capacitor 100B. FIG. 7 is a cross-sectional view of the negative-electrode-side fixed busbar 65.

Hereinafter, a thickness direction of the bottom 110 may be referred to as a Z direction, and a direction perpendicular to the Z direction may be referred to as a perpendicular direction. One direction perpendicular to the Z direction, specifically, a direction in which the positive-electrode-side Y-capacitor 100A and the negative-electrode-side Y-capacitor 100B are arranged is referred to as an X direction. The X direction corresponds to one direction. A direction perpendicular to both the Z direction and the X direction is referred to as a Y direction. Unless otherwise described, a shape viewed from the Z direction, i.e., a shape along an XY plane defined by the X direction and the Y direction is referred to as a planar shape. Further, a planar view from the Z direction is simply referred to as a planar view.

The housing 120 forms a container. The housing 120 is made of a metal material. The housing 120 is made by, for example, aluminum die casting. The housing 120 may be referred to as a metal housing. The housing 120 includes the bottom 110 and a side wall 115. The side wall 115 has a frame shape. The bottom 110 has a flat shape with a small thickness in the Z direction. The bottom 110 has a front surface 110A and the back surface 110B facing in the Z direction. The bottom 110 includes a flow path 117 through which a coolant passes between the front surface 110A and the back surface 110B. Since the coolant flows through the flow path 117, electric components fixed to the bottom 110 can be efficiently cooled. The smoothing capacitor 20 and the Y-capacitor 100 are fixed to the bottom 110. Thus, heat of the smoothing capacitor 20 and the Y-capacitor 100 can be efficiently cooled by the bottom 110.

Further, the side wall 115 is erected to extend away from the front surface 110A, thereby having the frame shape. The side wall 115 has a first side wall 111 and a second side wall 112 facing each other in the X direction, and a third side wall 113 and a fourth side wall 114 facing each other in the Y direction. The side wall 115 is continuous clockwise in the order of the first side wall 111, the third side wall 113, the second side wall 112, and the fourth side wall 114. An accommodation space 121 is defined in the housing 120 by the bottom 110 and the side wall 115. The inverter 11 and the smoothing capacitor 20 are accommodated in the accommodation space 121.

Parts of the power supply busbars 140 and 150 are fixed to the back surface 110B. The other parts of the power supply busbars 140 and 150 are provided on the front surface 110A. The inverter 11 and the smoothing capacitor 20 are electrically connected to each other by the power supply busbars 140 and 150 on the front surface 110A.

Ends of the power supply busbars 140 and 150 on the back surface 110B and ends of the power supply busbars 140 and 150 on the front surface 110A are connected. Power supply connectors leading to the high-voltage battery 2 are provided at the other ends of the power supply busbars 140 and 150 on the back surface 110B. Thus, electric power can be supplied from the high-voltage battery 2 to the Y-capacitor 100, the smoothing capacitor 20, and the inverter 11 via the power supply busbars 140 and 150.

The power supply busbars 140, and 150 include four electrically-conductive portions: first electrically-conductive portions 141 and 151, second electrically-conductive portions 142 and 152, third electrically-conductive portions 143 and 153, and fourth electrically-conductive portions 144 and 154. The first electrically-conductive portions 141 and 151 extend in the Y direction from the third side wall 113 toward the fourth side wall 114. The power supply connectors are connected to ends of the first electrically-conductive portions 141 and 151 beyond the third side wall 113. The second electrically-conductive portions 142 and 152 are connected to the other ends of the first electrically-conductive portions 141 and 151 facing the fourth side wall 114.

The second electrically-conductive portions 142 and 152 extend in the X direction toward the first side wall 111. The third electrically-conductive portions 143 and 153 are connected to the other ends of the second electrically-conductive portions 142 and 152 facing the first side wall 111. The third electrically-conductive portions 143 and 153 extend in the Y direction toward the fourth side wall 114. The fourth electrically-conductive portions 144 and 154 are connected to ends of the third electrically-conductive portions 143 and 153 facing the fourth side wall 114. The fourth electrically-conductive portions 144 and 154 extend in the X direction toward the second side wall 112. The ends of the positive-electrode-side power supply busbar 140 and the negative-electrode-side power supply busbar 150 on the front surface 110A are connected to ends of the fourth electrically-conductive portions 144 and 154 beyond the second side wall 112.

The electrically-conductive portions 141 to 143 of the positive-electrode-side power supply busbar 140 are located closer to the second side wall 112 than the electrically-conductive portions 151 to 153 of the negative-electrode-side power supply busbar 150 are. The positive-electrode-side Y-capacitor 100A is located closer to the second side wall 112 than the electrically-conductive portions 141 to 143 are. The negative-electrode-side Y-capacitor 100B is located closer to the first side wall 111 than the electrically-conductive portions 151 to 153 are. For example, the capacitor 100 is fixed to the back surface 110B via bolts, adhesive, or the like (not shown) in addition to the fastening members 91 and 92.

### Positive-Electrode-Side Y-Capacitor

A tip 163 of a side wall 162 of the positive-electrode-side case 160 is provided to face away from a tip 116 of the side wall 115 of the housing 120 in the Z direction. The three positive-electrode-side elements 31, 32 and 33 are arranged in the X direction in an internal space of the positive-electrode-side case 160. For example, the three positive-electrode-side elements 31, 32 and 33 are arranged in the order of the positive-electrode-side first element 31, the positive-electrode-side second element 32, and the positive-electrode-side third element 33 from the first side wall 111 toward the second side wall 112. The positive-electrode-side leads 31A, 32A and 33A, and the positive-electrode-side G-leads 31B, 32B and 33B extend in the Z direction from element portions of the positive-electrode-side elements 31, 32 and 33.

The three positive-electrode-side elements 31, 32 and 33 are arranged such that the positive-electrode-side first lead 31A, the positive-electrode-side second lead 32A, and the positive-electrode-side third lead 33A are adjacent to each other in the X direction. The three positive-electrode-side elements 31, 32 and 33 are arranged such that the positive-electrode-side first G-lead 31B, the positive-electrode-side second G-lead 32B, and the positive-electrode-side third G-lead 33B are adjacent to each other in the X direction. The positive-electrode-side leads 31A, 32A and 33A are provided closer to the third side wall 113 than the positive-electrode-side G-leads 31B, 32B and 33B are.

The positive-electrode-side Y-capacitor busbar 30 is thinner in thickness in the Z direction than the positive-electrode-side power supply busbar 140. In other words, a plate thickness of the positive-electrode-side Y-capacitor busbar 30 is thinner than a plate thickness of the positive-electrode-side power supply busbar 140. The positive-electrode-side first busbar 50 electrically connects the positive electrode of the high-voltage battery 2 and the positive-electrode-side leads 31A, 32A and 33A. The positive-electrode-side first busbar 50 has a comb shape with a portion extending in the Y direction that corresponds to a handle of the comb shape. The positive-electrode-side first busbar 50 includes a positive-electrode-side first extension portion 51 corresponding to the handle and three positive-electrode-side second extension portions 52, 53 and 54 corresponding to teeth of the comb shape. One end of the positive-electrode-side first extension portion 51 is connected to the third conductive portion 143 by welding or the like.

The positive-electrode-side first extension portion 51 is disposed between the positive-electrode-side leads 31A, 32A and 33A and the positive-electrode-side G-leads 31B, 32B and 33B in the Y direction. The positive-electrode-side first extension portion 51 extends in the X direction toward the second side wall 112 from a connection position with the third conductive portion 143. The positive-electrode-side first extension portion 51 is farther from the back surface 110B than the tip 163 of the positive-electrode-side case 160 and upper ends of the positive-electrode-side elements 31, 32 and 33 are. The positive-electrode-side elements 31, 32 and 33 are disposed closer to the back surface 110B than the positive-electrode-side first extension portion 51 is. The positive-electrode-side first extension portion 51 extends from the connection position with the third conductive portion 143 to a position overlapping the tip 163 and the upper ends of the element portions of the positive-electrode-side elements 31, 32 and 33.

The three positive-electrode-side second extension portions 52, 53 and 54 are integrally connected to positions of the positive-electrode-side first extension portion 51 which overlaps the positive-electrode-side elements 31, 32 and 33. The three positive-electrode-side second extension portions 52, 53 and 54 are a first parallel portion 52, a second parallel portion 53, and a third parallel portion 54 arranged in parallel in the X direction. The first parallel portion 52 is integrally connected to a position of the positive-electrode-side first extension portion 51 which overlaps the positive-electrode-side first element 31. The second parallel portion 53 is integrally connected to a position of the positive-electrode-side first extension portion 51 which overlaps the positive-electrode-side second element 32. The third parallel portion 54 is integrally connected to a position of the positive-electrode-side first extension portion 51 which overlaps the positive-electrode-side third element 33. The three positive-electrode-side second extension portions 52, 53 and 54 extend in the Y direction from the positive-electrode-side first extension portion 51 toward the corresponding positive-electrode-side leads 31A, 32A and 33A.

Through holes through which the positive-electrode-side leads 31A, 32A and 33A pass are defined at tips of the three positive-electrode-side second extension portions 52, 53 and 54. The corresponding positive-electrode-side leads 31A, 32A and 33A are inserted into the through holes and solder-connected. Thus, the positive-electrode-side second extension portions 52, 53 and 54 and the positive-electrode-side elements 31, 32 and 33 are electrically connected.

Further, one end of the positive-electrode-side fixed busbar 55 is integrally connected to the positive-electrode-side first extension portion 51. In the present embodiment, the one end of the positive-electrode-side first extension portion 51 is connected between the connection position with the third conductive portion 143 and the connection position with the first parallel portion 52. The positive-electrode-side first extension portion 51 has a longitudinal dimension in the X direction and a transverse dimension in the Y direction. The positive-electrode-side first extension portion 51 has ends in the X direction and the Y direction. As an example, the positive-electrode-side fixed busbar 55 is integrally connected to the end of the positive-electrode-side first extension portion 51 in the Y direction. A fixing position of the positive-electrode-side fixed busbar 55 is not limited as long as the positive-electrode-side fixed busbar 55 is disposed on the positive-electrode-side first extension portion 51.

The positive-electrode-side fixed busbar 55 extends in the Z direction from the positive-electrode-side first extension portion 51 toward the back surface 110B. As shown in FIG. 5, the positive-electrode-side first extension portion 51 and the positive-electrode-side fixed busbar 55 have a substantially L-shape in a cross-sectional view. A tip 56 of the positive-electrode-side fixed busbar 55 is spaced from the back surface 110B. The heat dissipation member 131 is disposed on the back surface 110B to cover the tip 56 of the positive-electrode-side fixed busbar 55. The heat dissipation member 131 is disposed at least between the tip 56 of the positive-electrode-side fixed busbar 55 and the back surface 110B.

Extending directions of the positive-electrode-side fixed busbar 55, the positive-electrode-side leads 31A, 32A and 33A, and the positive-electrode-side G-leads 31B, 32B and 33B are in the same direction. The positive-electrode-side fixed busbar 55 may not have a substantially L-shape in the cross-sectional view. For example, the positive-electrode-side fixed busbar 55 may have a substantially Z-shape in the cross-sectional view.

The positive-electrode-side second busbar 70 electrically connects the positive-electrode-side elements 31, 32 and 33 and the first ground 90A. The positive-electrode-side second busbar 70 includes the comb shape with a portion extending in the Y direction that corresponds to a handle of the comb shape. The positive-electrode-side second busbar 70 has a positive-electrode-side third extension portion 71 corresponding to the handle and three positive-electrode-side fourth extension portions 72, 73 and 74 corresponding to teeth of the comb shape. A fastened portion 75 including the fastening member 91 is provided at one end of the positive-electrode-side third extension portion 71. The fastened portion 75 is electrically connected to the first ground 90A via the fastening member 91.

The positive-electrode-side third extension portion 71 is disposed between the positive-electrode-side leads 31A, 32A and 33A and the positive-electrode-side G-leads 31B, 32B and 33B in the Y direction. The positive-electrode-side third extension portion 71 extends in the X direction toward the first side wall 111 from a connection position with the bottom 110. The positive-electrode-side third extension portion 71 is farther from the back surface 110B than the tip 163 and the upper ends of the positive-electrode-side elements 31, 32, 33 are. The positive-electrode-side elements 31, 32 and 33 are disposed closer to the back surface 110B than the positive-electrode-side third extension portion 71 is. The positive-electrode-side third extension portion 71 extends from the connection position with the bottom 110 to a position overlapping the tip 163 and the upper ends of the positive-electrode-side elements 31, 32 and 33.

The three positive-electrode-side fourth extension portions 72, 73 and 74 are integrally connected to positions of the extension portion 71, which overlap the positive-electrode-side elements 31, 32 and 33. The three positive-electrode-side fourth extension portions 72, 73 and 74 are a fourth parallel portion 72, a fifth parallel portion 73, and a sixth parallel portion 74 arranged in parallel in the X direction. The fourth parallel portion 72 is integrally connected to a position of the extension portion 71, which overlaps the positive-electrode-side first element 31. The fifth parallel portion 73 is integrally connected to a position of the extension portion 71, which overlaps the positive-electrode-side second element 32. The sixth parallel portion 74 is integrally connected to a position of the extension portion 71, which overlaps the positive-electrode-side third element 33. The three positive-electrode-side fourth extension portions 72, 73 and 74 extend in the Y direction from the positive-electrode-side third extension portion 71 toward the corresponding positive-electrode-side G-leads 31B, 32B and 33B.

Through holes through which the positive-electrode-side G-leads 31B, 32B and 33B pass are defined at tips of the three positive-electrode-side fourth extension portions 72, 73 and 74. The leads 31B, 32B and 33B corresponding to the through holes are inserted and solder-connected. Thereby, the positive-electrode-side fourth extension portions 72, 73 and 74 and the positive-electrode-side elements 31, 32 and 33 are electrically connected. The three positive-electrode-side elements 31, 32 and 33 are connected in parallel.

### Negative-Electrode-Side Y-Capacitor

A configuration of the negative-electrode-side Y-capacitor 100B is similar to the configuration of the positive-electrode-side Y-capacitor 100A. An arrangement of components of the negative-electrode-side Y-capacitor 100B is two-fold rotationally symmetric with an arrangement of corresponding components of the positive-electrode-side Y-capacitor 100A about a Z-axis. The Z-axis is an axis along the Z direction. One end of the negative-electrode-side first busbar 60 is connected to the third conductive portion 153 of the negative-electrode-side power supply busbar 150 by welding or the like.

The negative-electrode-side first busbar 60 includes a negative-electrode-side first extension portion 61, three negative-electrode-side second extension portions 62, 63 and 64, and a negative-electrode-side fixed busbar 65. The negative-electrode-side fixed busbar 65 includes a tip 66. The negative-electrode-side second busbar 80 has a negative-electrode-side third extension portion 81, three negative-electrode-side fourth extension portions 82, 83 and 84, and the fastened portion 85. A plate thickness of the negative-electrode-side Y-capacitor busbar 40 is thinner than a plate thickness of the negative-electrode-side power supply busbar 150. The negative-electrode-side first extension portion 61 corresponds to the positive-electrode-side first extension portion 51. The negative-electrode-side second extension portions 62, 63 and 64 correspond to the positive-electrode-side second extensions 52, 53 and 54. The negative-electrode-side fixed busbar 65 corresponds to the positive-electrode-side fixed busbar 55. The negative-electrode-side third extension portion 81 corresponds to the positive-electrode-side third extension portion 71. The negative-electrode-side fourth extension portions 82, 83 and 84 correspond to the positive-electrode-side fourth extension portions 72, 73 and 74. The fastened portion 85 corresponds to the fastened portion 75.

### Effects

In the following, effects regarding the positive-electrode-side Y-capacitor 100A will be described as a representative example. The effects are similar in the negative-electrode-side Y-capacitor 100B. The positive-electrode-side first busbar 50 connects the positive-electrode-side elements 31, 32 and 33 and the positive-electrode-side power supply busbar 140. The positive-electrode-side second busbar 70 connects the positive-electrode-side elements 31, 32 and 33 and the first ground 90A. The positive-electrode-side fixed busbar 55 extends from the positive-electrode-side first busbar 50 toward the bottom 110 and is fixed to the bottom 110. The heat dissipation member 131 is disposed between the positive-electrode-side fixed busbar 55 and the bottom 110.

A high current flows through the positive-electrode-side power supply busbar 140 based on a high voltage supplied from the high-voltage battery 2. Since the high current flows through the positive-electrode-side power supply busbar 140, the positive-electrode-side power supply busbar 140 generates heat and enters a high temperature state. One end of the positive-electrode-side first busbar 50 is connected to the positive-electrode-side power supply busbar 140. The positive-electrode-side elements 31, 32 and 33 are connected to the other end of the positive-electrode-side first busbar 50. Thus, heat is transferred from the positive-electrode-side power supply busbar 140 to the positive-electrode-side elements 31, 32 and 33 via the positive-electrode-side first busbar 50.

In the present embodiment, the positive-electrode-side fixed busbar 55 is disposed on the positive-electrode-side first busbar 50. The positive-electrode-side fixed busbar 55 is fixed to the bottom 110 via the heat dissipation member 131. Thus, heat is easily transferred from the positive-electrode-side fixed busbar 55 to the bottom 110. Accordingly, heat transmission to the positive-electrode-side elements 31, 32 and 33 is reduced. Temperature rise of the positive-electrode-side elements 31, 32 and 33 is reduced.

In recent years, with an increase in switching speed in the inverter 11 and severer EMC standards, stricter noise reduction than before is awaited. For noise removal, the Y-capacitor 100 is mounted on the electrical device 10 such as a power conversion device. Generally, capacitors are used at or below heat resistance temperature in consideration of self-heating and heat dissipation. Similarly, the Y-capacitor 100 is used at or below heat resistance temperature. In particular, the Y-capacitor 100 has the lowest heat resistance among components mounted on the electrical device 10. Thus, it is important to reduce heat transfer to the Y-capacitor 100 and reduce temperature rise of the Y-capacitor 100.

The positive-electrode-side fixed busbar 55 is disposed between a connection position of the positive-electrode-side first busbar 50 with the positive-electrode-side power supply busbar 140 and a connection position of the positive-electrode-side first busbar 50 with the positive-electrode-side elements 31, 32 and 33. According to this, heat is transferred from the positive-electrode-side fixed busbar 55 to the bottom 110 before being transferred to the positive-electrode-side elements 31, 32 and 33. Thus, heat transfer from the positive-electrode-side power supply busbar 140 to the positive-electrode-side elements 31, 32 and 33 can be efficiently reduced.

The multiple elements 31, 32 and 33 are arranged in the X direction, and are connected in parallel to the positive-electrode-side first busbar 50 and the positive-electrode-side second busbar 70 via solders 34, 35. According to this, even when lengths of the positive-electrode-side first extension portion 51 and the positive-electrode-side third extension portion 71 become long, vibration of the positive-electrode-side first busbar 50 and the positive-electrode-side second busbar 70 can be reduced. Heat transfer to the multiple positive-electrode-side elements 31, 32 and 33 can be reduced almost simultaneously.

The positive-electrode-side first busbar 50 and the positive-electrode-side second busbar 70 are arranged farther from the bottom 110 than the multiple positive-electrode-side elements 31, 32 and 33. An extending direction of the positive-electrode-side fixed busbar 55, an extending direction of the positive-electrode-side leads 31A, 32A and 33A, and an extending direction of the positive-electrode-side G-leads 31B, 32B and 33B are in the same direction. Since vibration is absorbed by the positive-electrode-side fixed busbar 55 and the heat dissipation member 131, vibration of the positive-electrode-side leads 31A, 32A and 33A and the positive-electrode-side G-leads 31B, 32B and 33B is reduced. Stress concentration on the solders 34 and 35 is reduced.

The flow path 117 for circulating the coolant is defined in the bottom 110. The Y-capacitor 100 is cooled by the coolant. According to this, a heat dissipation effect to the bottom 110 can be increased.

A plate thickness of the positive-electrode-side Y-capacitor busbar 30 is thinner than a plate thickness of the positive-electrode-side power supply busbar 140. According to this, heat of the positive-electrode-side power supply busbar 140 is less likely to be transferred to the positive-electrode-side Y-capacitor busbar 30. Accordingly, heat transfer from the positive-electrode-side power supply busbar 140 to the positive-electrode-side elements 31, 32 and 33 is reduced.

The positive-electrode-side first busbar 50 includes the positive-electrode-side first extension portion 51 and the positive-electrode-side second extension portions 52, 53 and 54. One end of the positive-electrode-side first extension portion 51 is connected to the third conductive portion 143 and extends in the X direction. One ends of the positive-electrode-side second extension portions 52, 53 and 54 are connected to the positive-electrode-side first extension portion 51 and extend toward the positive-electrode-side leads 31A, 32A and 33A. The positive-electrode-side second busbar 70 includes the positive-electrode-side third extension portion 71 and the positive-electrode-side fourth extension portions 72, 73, 74. One end of the positive-electrode-side third extension portion 71 is connected to the first ground 90A and extends in the X direction. One ends of the positive-electrode-side fourth extension portions 72, 73 and 74 are connected to the positive-electrode-side third extension portion 71 and extend toward the positive-electrode-side G-leads 31B, 32B and 33B. According to this, lengths of the positive-electrode-side second extension portions 52, 53 and 54 and the positive-electrode-side fourth extension portions 72, 73 and 74 can be adjusted according to sizes of the positive-electrode-side elements 31, 32 and 33. A design flexibility increases. The same effects can be also achieved in the negative-electrode-side Y-capacitor 100B.

The positive-electrode-side fourth extension portions 72, 73 and 74 of the positive-electrode-side Y-capacitor busbar 30 are connected to the first ground 90A. The negative-electrode-side fourth extension portions 82, 83 and 84 of the negative-electrode-side Y-capacitor busbar 40 are connected to the second ground 90B. Since the positive-electrode-side Y-capacitor busbar 30 and the negative-electrode-side Y-capacitor busbar 40 are separately connected to the corresponding grounds 90A and 90B, the design flexibility increases.

### Second Embodiment

In the first embodiment, the fixed busbars 55 and 65 are integrally connected to the first extension portions 51 and 61, which are positioned on the corresponding positive and negative electrode-sides. However, connecting positions of the fixed busbars 55 and 65 are not limited to this. For example, the fixed busbars 55 and 65 may be fixed to the third extension portions 71 and 81, which are positioned on the corresponding positive and negative electrode-sides.

FIG. 8 is a planar view of electrical device 10 according to a second embodiment viewed from the back surface 110B. The positive-electrode-side fixed busbar 55 is fixed between a connection position of the positive-electrode-side third extension portion 71 with the sixth parallel portion 74 and a connection position of the positive-electrode-side third extension portion 71 with the fastened portion 75. From that position, the positive-electrode-side fixed busbar 55 extends in the Z direction toward the bottom 110. The positive-electrode-side fixed busbar 55 is fixed to the bottom 110 via the heat dissipation member 131. The negative-electrode-side fixed busbar 65 is similar to the positive-electrode-side fixed busbar 55. This achieves the same effects as the first embodiment.

Although the present disclosure has been described based on the embodiments, it is understood that the present disclosure is not limited to the embodiments and structures. The present disclosure also includes various modifications and modifications within an equivalent range. In addition, various combinations and embodiments are shown in the present disclosure, but other combinations and embodiments including only one element, more, or less are also within the scope and spirit of the present disclosure.

What is claimed is:

1. An electrical device comprising:
a power supply busbar connected to a power source and an electric component;
a capacitor connected to the power supply busbar and connected to a ground;
a metal housing including a bottom to which the capacitor is fixed, the bottom being connected to the ground; and
a heat dissipation member having an electrically insulating property and a thermal conductivity higher than a thermal conductivity of air, wherein
the capacitor includes:
an element; and
a capacitor busbar including a first busbar connecting the element and the power supply busbar, a second busbar connecting the element and the ground, and a fixed busbar extending from the first busbar or the second busbar toward the bottom and fixed to the bottom, and
the heat dissipation member is disposed between the fixed busbar and the bottom.

2. The electrical device according to claim 1, wherein
the first busbar extends in a first direction, the first direction being a direction away from the power supply busbar, and
the fixed busbar extends from the first busbar and is disposed between a connection position of the first busbar with the power supply busbar and a connection position of the first busbar with the element.

3. The electrical device according to claim 1, wherein
the second busbar extends in a first direction, the first direction being a direction away from the ground, and
the fixed busbar extends from the second busbar and is disposed between a connection position of the second busbar with the ground and a connection position of the second busbar with the element.

4. The electrical device according to claim 2, wherein
the element is one of multiple elements,
the multiple elements are arranged in the first direction, and
the multiple elements are connected in parallel between the first busbar and the second busbar via solder.

5. The electrical device according to claim 4, wherein
the multiple elements are arranged between the bottom and the first busbar and between the bottom and the second busbar,
each of the multiple elements includes:
one end lead solder-connected to the first busbar; and
an other end lead solder-connected to the second busbar, and
a direction in which the one end lead and the other end lead extend is same as a direction in which the fixed busbar extends.

6. The electrical device according to claim 1, wherein
a coolant configured to cool at least the capacitor flows in the bottom.

7. The electrical device according to claim 1, wherein
a plate thickness of the capacitor busbar is thinner than a plate thickness of the power supply busbar.

8. The electrical device according to claim 5, wherein
the first busbar includes a first extension portion having one end connected to the power supply busbar and extending in the first direction, and a second extension portion extending from the first extension portion and connected to the one end lead, and
the second busbar includes a third extension portion having one end connected to the ground and extending in the first direction, and a fourth extension portion extending from the third extension portion and connected to the other end lead.

9. The electrical device according to claim 8, wherein
the capacitor busbar is one of capacitor busbars including:
a positive-electrode-side capacitor busbar connected to a positive electrode of the power source; and
a negative-electrode-side capacitor busbar connected to a negative electrode of the power source, and
the fourth extension portion of the positive-electrode-side capacitor busbar and the fourth extension portion of the negative-electrode-side capacitor busbar are separate bodies and are individually connected to the ground.
